(19) United States
(12) Patent Application Publication
(10) Pub. No.: US 2026/0088280 A1
(43) Pub. Date: Mar. 26, 2026

(54) CORE-SHELL CATHODE ACTIVE MATERIALS

(71) Applicant: SAMSUNG SDI CO., LTD., Yongin-si (KR)

(72) Inventors: Adam Joshua Morris-Cohen, Concord, MA (US); Yuanyuan Ma, Woburn, MA (US)

(21) Appl. No.: 18/898,262

(22) Filed: Sep. 26, 2024

(51) Int. Cl. H01M 4/36; H01M 4/02; H01M 4/131; H01M 4/505; H01M 4/525; H01M 10/0525

(52) U.S. Cl. CPC H01M 4/366; H01M 4/131; H01M 4/505; H01M 4/525; H01M 10/0525; H01M 2004/028

(57) ABSTRACT

A cathode active material including an interior and an exterior coating on the interior, and a total amount of lithium ions is provided. The interior has a layered metal oxide, the exterior coating has a lithium composite oxide having a spinel structure, and the cathode active material is for a rechargeable lithium battery having an upper charging limit voltage of at least 3.5 volt. The layered metal oxide includes about 70% to 90% of the total amount of lithium ions, and the lithium composite oxide includes about 5% to 20% of the total amount of lithium ions. A method of operating a rechargeable lithium battery including the cathode active material wherein a ratio of initial charge capacity of the interior to initial charge capacity of the exterior coating is about 5 to 50 is also provided.

### BACKGROUND

### 1. Field

One or more embodiments of the present disclosure relate to a cathode (e.g., positive electrode) active material, a rechargeable lithium battery including the same, and a method of operating the rechargeable lithium battery.

### 2. Description of the Related Art

A consumer electronic device such as a smart phone, a laptop, and/or the like, or an electric vehicle use a rechargeable lithium battery having high energy density and easy portability as a driving power source. In response to the recent rapid spread of devices using rechargeable lithium batteries, research to develop a rechargeable lithium battery having relatively high capacity and high energy density has been actively conducted.

Cathode active materials that have been investigated to implement rechargeable lithium batteries include Ni-rich layered oxides such as lithium nickel-based oxide, lithium nickel manganese cobalt composite oxide, and lithium nickel cobalt aluminum composite oxide. While large, high capacity, high voltage, or high energy density rechargeable lithium batteries may be implemented using Ni-rich layered oxides, the bulk-phase and surface stability of these materials is weak, for example, at a high state-of-charge or elevated temperature. Accordingly, there is a desire to improve the stability of the cathode active material for use in a high capacity or a high energy density rechargeable lithium battery even if operated at high voltage.

### SUMMARY

One or more aspects of embodiments of the present disclosure are directed toward a cathode active material including an interior and an exterior coating on the interior, and a total amount of lithium ions, the interior including a layered metal oxide, the exterior coating including a lithium composite oxide having a spinel structure, the cathode active material being for a rechargeable lithium battery having an upper charging limit voltage of, at least, about 3.5 volt (V), the layered metal oxide including about 70% to about 90% of the total amount of lithium ions, and the lithium composite oxide including about 5% to about 20% of the total amount of lithium ions.

In one or more embodiments, the layered metal oxide has a high cutoff voltage V_{HI} and a low cutoff voltage V_{LO}, the low cutoff voltage V_{LO} being, at most, about 2.5 V, the lithium composite oxide has a lithiation onset voltage V_{Li} and a dilithiation onset voltage V_{De-Li}, the dilithiation onset voltage V_{De-Li} being greater than the high cutoff voltage V_{HI} and, at least, about 4.6 V, and the lithiation onset voltage V_{Li} being less than the low cutoff voltage V_{LO}.

In one or more embodiments, the layered metal oxide is represented by Chemical Formula 1 and the lithium composite oxide is represented by Chemical Formula 2.

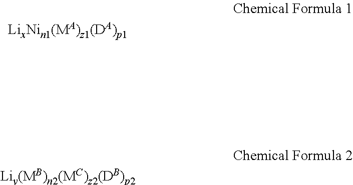

In Chemical Formula 1 and Chemical Formula 2, M^{A} may be aluminum (Al), cobalt (Co), manganese (Mn), chromium (Cr), iron (Fe), magnesium (Mg), strontium (Sr), vanadium (V), a rare earth element, or a combination thereof, M^{B} and M^{C} may each independently be aluminum (Al), nickel (Ni), cobalt (Co), manganese (Mn), chromium (Cr), iron (Fe), magnesium (Mg), strontium (Sr), vanadium (V), a rare earth element, or a combination thereof, D^{A} and D^{B} may each independently be oxygen (O), fluorine (F), sulfur(S), phosphorous (P), or a combination thereof, x may be a real number from 0 to 1.5, y may be a real number from 0 to 2, n1 may be a real number from 0.8 to 1, n2 may be a real number from 0 to 1, z1 may be a real number from 0 to 0.3, z2 may be a real number from 0 to 2, p1 may be a real number from 1.8 to 4, p2 may be a real number from 1.8 to 2, and n1+z1 and n2+z2 each equal 1.

In one or more embodiments, the cathode active material may include particles having a core and shell on the core, the core including the layered metal oxide and the shell including the lithium composite oxide, an average particle diameter of the particles may be about 30 micrometer (μm), and an average particle diameter of the core may be about 60% to about 90% of the average particle diameter of the particles.

In one or more embodiments, the particles have an external region having a first inner boundary and a first surface coincident with a surface of the shell, and the external region has a first thickness of about 5% to about 40% of the average particle diameter. The particles have a middle region having a second inner boundary and a second surface coincident with the first inner boundary, and the middle region has a second thickness of about 5% to about 40% of the average particle diameter. The particles have an internal region having a third surface and a sphere-like shape having a diameter of about 60% to about 90% of the average particle diameter.

One or more aspects of embodiments are directed toward a cathode including a cathode current collector and a cathode active material layer on the cathode current collector, wherein the cathode active material layer includes the aforementioned cathode active material.

One or more aspects of embodiments are directed toward a rechargeable lithium battery including the cathode, an anode, and an electrolyte.

One or more aspects of embodiments are directed toward a method of operating the rechargeable lithium battery, for example, between about 2.3 V and about 5 V.

In one or more embodiments, the method provides a ratio (B/A) of an initial charge capacity (B) of the interior to an initial charge capacity (A) of the exterior coating that may be about 5 to about 50.

In one or more embodiments of the method, the layered metal oxide may release about 40% to about 100% of an electromotive lithium ion capacity and may retain about 1% to about 30% of the electromotive lithium ion capacity, based on a theoretical electromotive lithium ion capacity of the layered metal oxide.

In one or more embodiments of the method, the lithium composite oxide may release about 5% to about 30% of an electromotive lithium ion capacity and may retain about 40% to about 98% of the electromotive lithium ion capacity, based on a theoretical electromotive lithium ion capacity of the lithium composite oxide.

Additional aspects of embodiments will be set forth in part in the description which follows and, in part, will be apparent from the description, or may be learned by practice of the presented embodiments of the disclosure.

The cathode active material according to one or more embodiments has high capacity and long cycle-life characteristics, and improved stability even at high voltage. High initial charge/discharge capacity and efficiency and long cycle-life properties may be achieved under high-voltage operating conditions in a rechargeable lithium battery that includes the cathode active material.

### BRIEF DESCRIPTION OF THE DRAWINGS

The preceding and other objects and features of embodiments of the present disclosure will become more apparent to those of ordinary skill in the art by describing example embodiments thereof in more detail with reference to the accompanying drawings. In the drawings:

FIG. 1 is a first cycle voltage profile for lithium nickel oxide LiNiO₂.

FIG. 2 is a graph showing lithiation and dilithiation as a function of applied voltage for the spinel LiMn₂O₄.

FIGS. 3A-3E are voltage profiles for spinel materials LiNi_{0.1}Mn_{1.9}O₄, LiNi_{0.2}Mn_{1.8}O₄, LiNi_{0.3}Mn_{1.7}O₄, LiNi_{0.4}Mn_{1.6}O₄, and LiNi_{0.5}Mn_{1.5}O₄.

FIG. 4 is a cutaway perspective view schematically showing a rechargeable lithium battery according to one or more embodiments.

FIG. 5 is a cross-sectional view schematically showing a rechargeable lithium battery according to one or more embodiments.

FIGS. 6-7 are perspective views schematically showing rechargeable lithium batteries according to one or more embodiments.

### DETAILED DESCRIPTION

In order to sufficiently understand the configuration and effect of embodiments of the present disclosure, example embodiments of the present disclosure will be described in more detail with reference to the accompanying drawings, and may be easily practiced by a person skilled in the art. However, it should be noted that this is provided by way of example, and the present disclosure is not limited thereby and is only defined by the scope of the appended claims, and equivalents thereof, described in more detail herein. Rather, the example embodiments are provided only to disclose the subject matter of the present disclosure and let those skilled in the art fully know the scope of the present disclosure.

In the drawings, the thickness of layers, films, panels, regions, and/or the like, may be exaggerated for clarity and like reference numerals designate like elements throughout, and duplicative descriptions thereof may not be provided in the specification. Unless stated otherwise in the specification, if a portion of a layer, film, region, plate and/or the like is referred to as being “on” another portion, this includes not only the case in which the portion is “directly on” another portion but also the case in which there is another portion interposed therebetween.

Unless stated otherwise in the specification, singular expressions may include plural expressions. Also, unless stated otherwise, “A or B” may refer to “including A, including B, or including A and B.”

In the specification, a “combination thereof” may refer to a mixture, laminate, composite, copolymer, alloy, blend, and/or reaction product of constituents.

The terms “comprises,” comprising,” “comprise,” “including,” “includes,” “include,” “having,” “has,” and “have,” as used in this description, are intended to designate the presence of an embodied aspect, number, act, task, element, and/or a (e.g., any suitable) combination thereof. However, the use of these terms does not preclude or exclude the possibility of the presence or addition of one or more other components, features, numbers, acts, tasks, elements, and/or a (e.g., any suitable) combination thereof.

In one or more embodiments, the term “layer” herein includes not only a shape formed or provided on the whole surface if viewed from a plan view, but also a shape formed or provided on a partial surface.

It will be understood that, although the terms “first,” “second,” “third,” and/or the like may be utilized herein to describe one or more suitable elements, components, regions, layers and/or sections, these elements, components, regions, layers and/or sections should not be limited by these terms. These terms are only utilized to distinguish one element, component, region, layer or section from another element, component, region, layer, or section. Thus, a first element, component, region, layer, or section described herein may be termed a second element, component, region, layer or section without departing from the teachings set forth herein.

As utilized herein, the term “and/or” includes any, and all, combinations of one or more of the associated listed items. Expressions such as “at least one of,” “one of,” and “selected from,” if preceding a list of elements, modify the entire list of elements and do not modify the individual elements of the list. For example, the expressions “at least one of a to c,” “at least one of a, b or c,” and “at least one of a, b and/or c” may indicate only a, only b, only c, both (e.g., simultaneously) a and b, both (e.g., simultaneously) a and c, both (e.g., simultaneously) b and c, all of a, b, and c, or variations thereof.

Spatially relative terms, such as “beneath,” “below,” “lower,” “above,” “upper,” and/or the like, may be utilized herein to easily describe the relationship between one element or feature and another element or feature. It will be understood that the spatially relative terms are intended to encompass different orientations of a device in utilization or operation in addition to the orientation illustrated in the drawings. For example, if the device in the drawings is turned over, elements described as “below” or “beneath” other elements or features will be oriented “above” the other elements or features. Thus, the example term “below” can encompass both (e.g., simultaneously) the orientations of above and below. The device may be otherwise oriented (rotated 90 degrees or at other orientations), and the spatially relative terms utilized herein may be interpreted accordingly.

Unless otherwise defined, all terms (including chemical, technical and scientific terms) utilized herein have the same meaning as commonly understood by one of ordinary skill in the art to which this disclosure pertains. It will be further understood that terms, such as those defined in commonly utilized dictionaries, should be interpreted as having a meaning that is consistent with their meaning in the context of the related art and the present disclosure, and will not be interpreted in an idealized or overly formal sense.

Example embodiments may be described herein with reference to cross-sectional views, which are schematic views of idealized embodiments. As such, variations from the shapes of the illustrations as a result, for example, of manufacturing techniques and/or tolerances, are to be expected. Thus, embodiments described herein should not be construed as being limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the drawings are schematic in nature and their shapes are not intended to illustrate the precise shape of a region and are not intended to limit the scope of the appended claims.

The term “may” will be understood to refer to “one or more embodiments of the present disclosure,” some of which include the described element and some of which exclude that element and/or include an alternate element. Similarly, alternative language such as “or” refers to “one or more embodiments of the present disclosure,” each including a corresponding listed item. Descriptions of features or aspects within each embodiment should typically be considered as available for other similar features or aspects in other embodiments.

In this context, “consisting essentially of” indicates that any additional components will not materially affect the chemical, physical, optical and/or electrical properties of the semiconductor film.

Further, in this specification, the phrase “plan view,” indicates viewing a target portion from the top, and the phrase “on a cross-section” indicates viewing a cross-section formed by vertically cutting a target portion from the side.

In the context of the present application and unless otherwise defined, the terms “use,” “using,” and “used” may be considered synonymous with the terms “utilize,” “utilizing,” and “utilized,” respectively.

The term “particle diameter” as utilized herein refers to an average diameter of particles if the particles are spherical, and refers to an average major axis length of particles if the particles are non-spherical. For example, the average particle diameter may be measured by any suitable method in the art, for example, by a particle size analyzer, and/or by a transmission electron microscopic image and/or a scanning electron microscopic image. A value for the average particle diameter may be obtained by dynamic light scattering analysis methodology, performing data analysis, counting the number of particles for each particle size range, and calculating the data obtained. Unless otherwise defined, the average particle diameter may refer to the diameter (D₅₀) of particles having a cumulative volume of 50 volume % in the particle size distribution. If measuring by laser diffraction, for example, the particles to be measured are dispersed in a dispersion medium and then introduced into a related art laser diffraction particle size measuring device (e.g., MT 3000 available from Microtrac, Ltd.) utilizing ultrasonic waves at about 28 kHz, and after irradiation with an output of 60 W, the average particle diameter (D50) based on 50% of the particle size distribution in the measuring device may be calculated. As utilized herein, if (e.g., when) a definition is not otherwise provided, the average particle diameter refers to a diameter (D₅₀) of particles having a cumulative volume of 50 volume % in the particle size distribution that is obtained by measuring the size (diameter or major axis length) of about 20 particles at random in a scanning electron microscopic image.

### Cathode Active Material

In one or more embodiments, a cathode active material includes an interior that may be or include a layered metal oxide and an exterior coating on (e.g., surrounding partially or entirely) the interior that may be or include a lithium composite oxide having a spinel structure. The cathode active material has a total amount of lithium ions (Li⁺) that intercalate into the cathode active material during the discharge process of a rechargeable lithium battery, which powers a cell phone, electric vehicle, and/or the like. For example, the amount of lithium ions (Li⁺) in the cathode active material may be greatest if the battery is fully discharged and this amount decreases during the charging process as lithium ions (Li⁺) are released from the cathode (positive electrode) and enter the anode (negative electrode). An amount of lithium ions (Li⁺) in the layered metal oxide of the interior may be about 70% to about 90% and an amount of lithium ions (Li⁺) in the lithium composite oxide of the exterior coating may be about 5% to about 20%, based on the total amount of lithium ions (Li⁺) in the cathode active material, (e.g., if the battery is fully discharged). The cathode active material may be for (e.g., utilized in) a rechargeable lithium battery having an upper charging limit voltage of, at least, about 3.5 volt (V).

### Layered Metal Oxide

The layered metal oxide of the interior may be a deep-cycling cathode active material (CAM) having an excellent or suitable theoretical capacity of about 270 milliampere hour per gram (mAh/g) and an average operating voltage of about 3.6 V (e.g., relative to Li⁺/Li). In some embodiments, the theoretical capacity of the layered metal oxide may be about 180 mAh/g to about 270 mAh/g, about 200 mAh/g to about 260 mAh/g, or about 220 mAh/g to about 250 mAh/g. The term “deep-cycling,” as used herein, is a CAM that is lithiated and delithiated to, at least, about 80% to about 95% of theoretical capacity if fully discharged and charged, respectively.

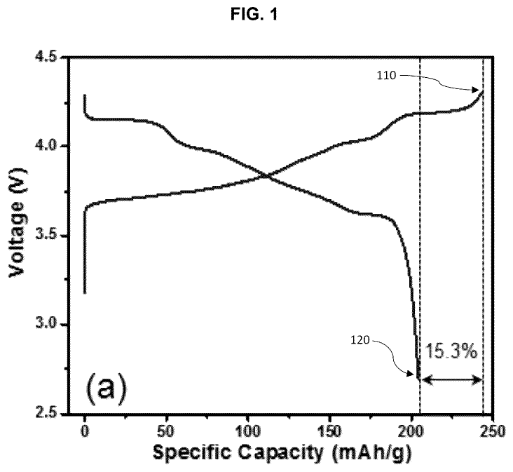

It will be understood that layered metal oxides (e.g., Ni-rich layered oxides) have poor material stability and are prone to both surface and bulk phase transformations, (e.g., at a high state-of-charge or elevated temperature), and suffer from surface instability, (e.g., at relatively high cutoff voltages (e.g., about 4.7 V)). Undesired reactions at the surface of the CAM during repeated charge/discharge of the battery lead to deterioration and/or degradation that reduce capacity, cycle life, and performance characteristics of the battery. For example, FIG. 1 shows a first cycle voltage profile for a deep-cycling CAM LiNiO₂ that has a theoretical capacity of about 250 mAh/g at a high cutoff voltage 110 that is about 4.3 V. LiNiO₂ was cycled between 4.3 V and 2.7 V and exhibited an initial discharge capacity of 205 mAh/g, which represents an initial capacity loss of 15.3%. In subsequent cycles the capacity degraded to only 160 mAh/g at the end of the 45th cycle. In FIG. 1, a low cutoff voltage 220 is about 2.7 V and indicates a minimum voltage of a suitable voltage range of 4.3 V to 2.7 V for LiNiO₂, (e.g., between the high cutoff voltage 110 and the low cutoff voltage 120). See, Xu, J., et al. ACS Applied Materials & Interfaces, 2016, 8, 31677-31683, the entire content of which is herein incorporated by reference.

The layered metal oxide of the present disclosure has a high cutoff voltage V_{HI} and a low cutoff voltage V_{LO} that are maximum and minimum values, respectively, of a suitable voltage range at which a rechargeable lithium battery including the layered metal oxide should be operated. The low cutoff voltage V_{LO} according to one or more embodiments may be, at most, about 2.5 V. For example, the low cutoff voltage V_{LO} may be about 2.5 V to about 3.4 V, about 2.7 V to about 3.2 V, or about 2.9 V to about 3.2 V. It is understood that the preceding ranges include all sub-ranges, other ranges beginning and/or ending with any point within these ranges, and single values within the ranges. For example, while a range of about 2.5 V to about 3.4 V is disclosed, the low cutoff voltage V_{LO} is also contemplated to be about 2.5 V, 2.6 V, 2.7 V, 2.8 V, 2.9 V, 3 V, 3.1 V, 3.2 V, 3.3 V, 3.4 V, 3.5 V, 3.6 V, 3.7 V, 3.8 V, 3.9 V, 4 V, 4.1 V, 4.2 V, 4.3 V, 4.4 V, 4.5 V, 4.6 V, or a value falling in between any two of the preceding single values.

In one or more embodiments, the layered metal oxide may be represented by, for example, Chemical Formula 1.

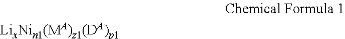

In Chemical Formula 1, M^{A} may be aluminum (Al), cobalt (Co), manganese (Mn), chromium (Cr), iron (Fe), magnesium (Mg), strontium (Sr), vanadium (V), a rare earth element, or a combination thereof, and D^{A} may be oxygen (O), fluorine (F), sulfur (S), phosphorous (P), or a combination thereof. In one or more embodiments, M^{A} may be manganese (Mn) and D^{A} may be oxygen (O).

In Chemical Formula 1, x may be a real number from 0 to 1.5, n1 may be a real number from 0.8 to 1, z1 may be a real number from 0 to 0.3, p1 may be a real number from 1.8 to 4, and n1+z1 may equal 1. For example, 0≤x≤1.5, 0.8≤n1≤1, 0≤z1≤0.3, and 1.8≤p1≤4.

In one or more embodiments, the layered metal oxide may be represented by Chemical Formula 1A.

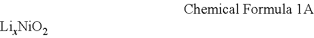

In Chemical Formula 1A, x may be a real number from 0 to 1, (e.g., 0≤x≤1).

In one or more embodiments, the layered metal oxide may be at least one selected from among a lithium nickel-based composite oxide, a lithium cobalt-based composite oxide, a lithium nickel-cobalt-aluminum-based composite oxide (NCA-based composite oxide), and a lithium nickel-manganese-cobalt-based composite oxide (NMC-based composite oxide). Herein, the term “based composite oxide,” is a CAM oxide material that includes elements (e.g., metal elements) in addition to the elements in the name of the CAM. In one or more embodiments, the layered metal oxide may be at least one selected from among lithium nickel oxide (LiNiO₂), lithium cobalt oxide (LiCoO₂), lithium nickel cobalt aluminum oxide (NCA) (LiNiCoAlO₂), and lithium nickel manganese cobalt oxide (NMC) (LiNiCoMnO₄).

In the layered metal oxide, an amount of lithium ions may be about 60% to about 98%, about 65% to about 95%, about 70% to about 90%, about 75% to about 85%, or about 60% to about 80%, of the total amount of lithium ions in the cathode active material, (e.g., if the battery is fully discharged). For example, the amount of lithium ions in the layered metal oxide may be about 60 mol % to about 98 mol %, about 65 mol % to about 95 mol %, about 70 mol % to about 90 mol %, about 75 mol % to about 85 mol %, or about 60 mol % to about 80 mol %, based on 100 mol % of lithium ions in the cathode active material, (e.g., if the battery is fully discharged). If the amount of lithium ions in the layered metal oxide satisfies the preceding ranges, high-cycling and/or high-voltage characteristics of the cathode active material may be improved.

In one or more embodiments, an amount of the layered metal oxide may be about 10 parts by weight to about 90 parts by weight, about 20 parts by weight to about 80 parts by weight, about 30 parts by weight to about 70 parts by weight, or about 40 parts by weight to about 90 parts by weight, based on 100 parts by weight of the cathode active material.

### Lithium Composite Oxide

The lithium composite oxide of embodiments of the present disclosure may be a spinel, (e.g., a high-voltage spinel), and may be a shallow-cycling cathode active material (CAM). The term “shallow-cycling,” as used herein, is a CAM that is lithiated and delithiated to, at most, about 20% to about 50% of theoretical capacity if fully discharged and charged, respectively. The shallow-cycling characteristics of the lithium composite oxide according to one or more embodiments improve the material stability of the exterior coating and the CAM.

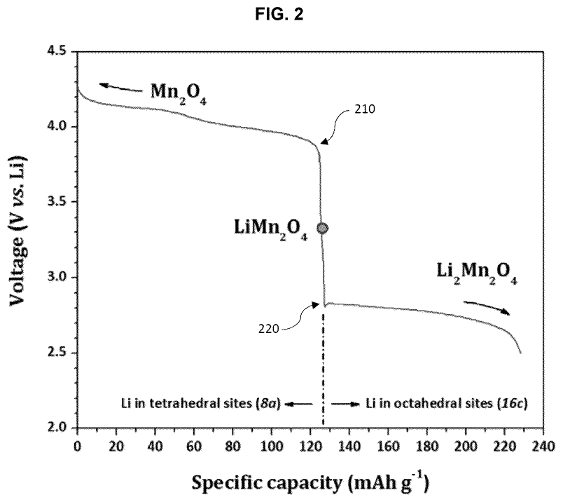

FIG. 2 shows the relationship between lithiation and dilithiation of a spinel structure and voltage for the spinel LiMn₂O₄ that has a specific capacity of about 126 to 128 milliampere hour per gram (mAh/g). As the voltage rises to a dilithiation onset voltage 210 (or more) the spinel LiMn₂O₄ is delithiated and converted to manganese (IV) oxide (Mn₂O₄). Conversely, as the voltage drops to a lithiation onset voltage 220 (or less) the spinel acquires additional lithium and is converted to a tetragonal rock salt compound, (Li₂Mn₂O₄). In FIG. 2, the dilithiation onset voltage 210 is about 3.8 volts (V) and the lithiation onset voltage 220 is about 2.8 V. The vertical section of the curve in FIG. 2 between about 2.8 V and about 3.8 V represents a suitable operational voltage range at which the spinel LiMn₂O₄ has shallow-cycling characteristics and a highly stable structure. See, Huang, Y., et al. Advanced Energy Materials, 2021, 11, 200997, Zhong, Q., et al. Journal of Electrochemical Society, 1997, 144, 205, Zhang, W., et al. Chemistry of Materials, 2018, 30, 2287, and Ren, W., et al. Ionics, 2014, 20, 1361, the entire content of each of which is herein incorporated by reference.

The lithium composite oxide has a lithiation onset voltage V_{Li} and a dilithiation onset voltage V_{De-Li}, the quantitative value of each of which are determined by the chemical composition of the lithium composite oxide, as described in more detail elsewhere herein. If operated at a voltage of about, or less than, the lithiation onset voltage V_{Li}, the lithium composite oxide (e.g., spinel) may acquire additional lithium and transform into a different compound (e.g., Li₂Mn₂O₄). If operated at a voltage of about, or more than, the dilithiation onset voltage V_{De-Li}, the lithium composite oxide (e.g., spinel) may release lithium and transform into a different compound (e.g., Mn₂O₄). If operated at a voltage range between, at least, the lithiation onset voltage V_{Li} and, at most, the dilithiation onset voltage V_{De-Li}, the lithium composite oxide has shallow-cycling characteristics and/or is materially stable and impervious (e.g., not prone) to degradation and/or deterioration. The lithium composite oxide in the exterior coating surrounds and protects the layered metal oxide in the interior (e.g., from structural deterioration and/or degradation which occur predominately at the surface of the CAM). As a result, use of the CAM of the present disclosure in a high-voltage rechargeable lithium battery may improve stability and cycle-life characteristics while maximizing or increasing capacity and energy density.

The dilithiation onset voltage V_{De-Li} according to one or more embodiments may be, at least, about 4.6 V. For example, the dilithiation onset voltage V_{De-Li} may be about 4.6 V to about 5.5 V, about 4.7 V to about 5.2 V, about 4.8 V to about 5 V, or about 4.6 V to about 5 V. While a range of about 4.6 V to about 5.5 V is disclosed, the dilithiation onset voltage V_{De-Li} is also contemplated to be about 4.6 V, 4.7 V, 4.8 V, 4.9 V, 5 V, 5.1 V, 5.2 V, 5.3 V, 5.4 V, 5.5 V, or a value falling in between any two of the preceding single values. The dilithiation onset voltage V_{De-Li} of the lithium composite oxide according to one or more embodiments may be greater than the high cutoff voltage V_{HI} of the layered metal oxide. For example, the dilithiation onset voltage V_{De-Li} may be about 5% to about 50%, about 10% to about 40%, or about 20% to about 30%, greater than the high cutoff voltage V_{HI}. While a range of about 5% to about 50% is disclosed, the dilithiation onset voltage V_{De-Li} is also contemplated to be about 5%, 10%, 15%, 20%, 25%, 30%, 35%, 40%, 45%, or 50%, greater than the high cutoff voltage V_{HI}, or a value falling in between any two of the preceding single values. In some embodiments, the high cutoff voltage V_{HI} may be about 3.8 V and the dilithiation onset voltage V_{De-Li} may be about 4.4 V to, at least, about 4.6 V, or the high cutoff voltage V_{HI} may be about 4 V and the dilithiation onset voltage V_{De-Li} may be about 4.5 V to, at least, about 4.8 V, or the high cutoff voltage V_{HI} may be about 4.2 V and the dilithiation onset voltage V_{De-Li} may be about 4.6 V to, at least, about 5 V, or the high cutoff voltage V_{HI} may be about 4.4 V and the dilithiation onset voltage V_{De-Li} may be about 4.7 V to, at least, about 5 V.

The lithiation onset voltage V_{Li} according to one or more embodiments may be less than the low cutoff voltage V_{LO} of the layered metal oxide. For example, the lithiation onset voltage V_{Li} may be about 5% to about 50%, about 10% to about 40%, or about 20% to about 30%, less than the low cutoff voltage V_{LO}. While a range of about 5% to about 50% is disclosed, the lithiation onset voltage V_{Li} is also contemplated to be about 5%, 10%, 15%, 20%, 25%, 30%, 35%, 40%, 45%, or 50%, less than the low cutoff voltage V_{LO}, or a value falling in between any two of the preceding single values. In some embodiments, the low cutoff voltage V_{LO} may be about 2.2 V and the lithiation onset voltage V_{Li} may be about 1.6 V to about 2 V, or the low cutoff voltage V_{LO} may be about 2.5 V and the lithiation onset voltage V_{Li} may be about 1.8 V to about 2.3 V, or the low cutoff voltage V_{LO} may be about 2.8 V and the lithiation onset voltage V_{Li} may be about 2.1 V to about 2.5 V, or the low cutoff voltage V_{LO} may be about 3.2 V and the lithiation onset voltage V_{Li} may be about 2.5 V to about 3 V.

In one or more embodiments, the lithium composite oxide may have a spinel structure, or may be a spinel, and may be represented by, for example, Chemical Formula 2.

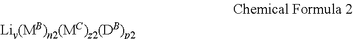

In Chemical Formula 2, M^{B} and M^{C} may each independently be aluminum (AI), nickel (Ni), cobalt (Co), manganese (Mn), chromium (Cr), iron (Fe), magnesium (Mg), strontium (Sr), vanadium V), a rare earth element, or a combination thereof, and D^{B} may be oxygen (O), fluorine (F), sulfur(S), phosphorous (P), or a combination thereof. In one or more embodiments, M^{B} may be nickel (Ni), M^{B} may be manganese (Mn), and D^{B} may be oxygen (O).

In Chemical Formula 2, y may be a real number from 0 to 2, n2 may be a real number from 0 to 1, z2 may be a real number from 0 to 2, p2 may be a real number from 1.8 to 2, and n2+z2 may equal 1. For example, 0≤y≤2, 0≤n2≤1, 0≤z2≤2, and 1.8≤p1≤2.

In one or more embodiments, the lithium composite oxide may be represented by Chemical Formula 2A.

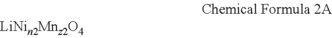

In Chemical Formula 2A, n2 may be a real number from 0 to 0.6, and z2 may be a real number from 1.4 to 2, e.g., 0≤n2≤0.6 and 1.4≤z2≤2. In one or more embodiments, z2 may be determined by Equation 1.

$$z 2 = 2 - n 2 \qquad Equation 1$$

In one or more embodiments, n2 may be 0.2 and z2 may be 1.8, n2 may be 0.3 and z2 may be 1.7, n2 may be 0.4 and z2 may be 1.6, or n2 may be 0.5 and z2 may be 1.5. For example, the lithium composite oxide may be a spinel material including at least one selected from among Li_{y1}Mn₂O₄, Li_{y1} Ni_{0.1}Mn_{1.9}O₄, Li_{y1} Ni_{0.2}Mn_{1.8}O₄, Li_{y1} Ni_{0.3}Mn_{1.7}O₄, Li_{y1} Ni_{0.4}Mn_{1.6}O₄, and Li_{y1}Ni_{0.5}Mn_{1.5}O₄, and y1 may be a real number from 0 to 1, (e.g., 0≤y1≤1.0). For example, y1 may be 1.

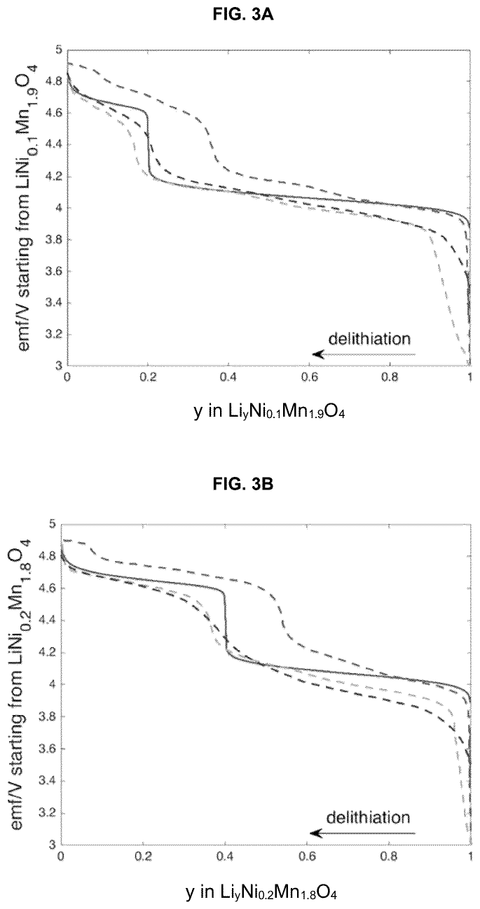

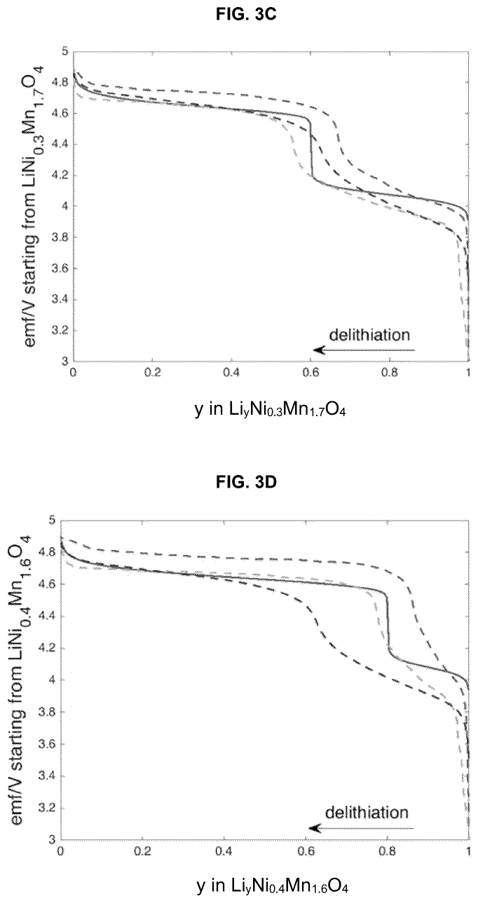

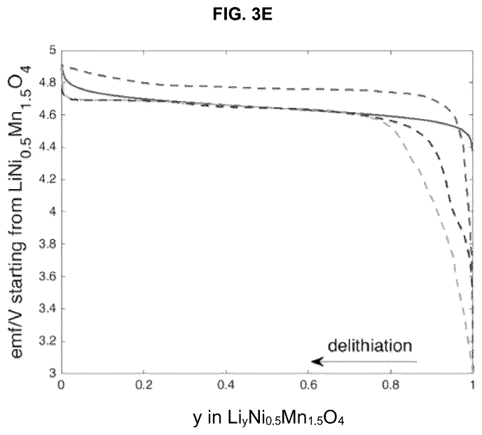

FIGS. 3A-3E each show a solid line for the voltage profile of a spinel that is fully discharged where y equals 1, and has a lithiation onset voltage V_{Li} and a dilithiation onset voltage V_{De-Li} which define a suitable voltage range wherein the spinel has shallow-cycling characteristics and suitable or excellent material stability. FIG. 3A shows the voltage profile for spinel LiNi_{0.1}Mn_{1.9}O₄ V_{Li} and V_{De-Li} of 4.22 V and 4.55 V, respectively. Within the suitable voltage spinel LiNi_{0.1}Mn_{1.9}O₄ has released about 80% and retains about 20% of its electromotive lithium ion capacity, based on a theoretical electromotive lithium ion capacity of LiNi_{0.1}Mn_{1.9}O₄. FIG. 3B shows the voltage profile for spinel LiNi_{0.2}Mn_{1.8}O₄ V_{Li} and V_{De-Li} of 4.22 V and 4.85 V, respectively. Within the suitable voltage range spinel LiNi_{0.2}Mn_{1.8}O₄ has released about 60% and retains about 40% of its electromotive lithium ion capacity, based on a theoretical electromotive lithium ion capacity for LiNi_{0.2}Mn_{1.8}O₄. FIG. 3C shows the voltage profile for spinel LiNi_{0.3}Mn_{1.7}O₄ V_{Li} and V_{De-Li} of 4.22 V and 4.55 V, respectively. Within the suitable voltage range spinel LiNi_{0.3}Mn_{1.7}O₄ has released about 40% and retains about 60% of its electromotive lithium ion capacity, based on a theoretical electromotive lithium ion capacity for LiNi_{0.3}Mn_{1.7}O₄. FIG. 3D shows the voltage profile for spinel LiNi_{0.4} Mn_{1.6}O₄ V_{Li} and V_{De-Li} of 4.25 V and 4.47 V, respectively. Within the suitable voltage range spinel LiNi_{0.4} Mn_{1.6}O₄ has released about 20% and retains about 80% of its electromotive lithium ion capacity, based on a theoretical electromotive lithium ion capacity for LiNi_{0.4} Mn_{4.6}O₄. FIG. 3E shows the voltage profile for spinel LiNi_{0.5}Mn_{1.5}O₄ V_{De-Li} about 4.4 V as an upper voltage at which the spinel has shallow-cycling characteristics, and suitable or excellent material stability. At or less than about 4.4 V spinel LiNi_{0.5}Mn_{1.5}O₄ retains about 100% of its electromotive lithium ion capacity, based on a theoretical electromotive lithium ion capacity of LiNi_{0.5}Mn_{1.5}O₄. See, Li, D., et al. Journal of Electrochemical Society, 2020, 167, 130511, the entire content of which is herein incorporated by reference.

In one or more embodiments, the lithium composite oxide may be a spinel material including at least one selected from among LiMn₂O₄, LiMn₃O₄, LiMnO₂, Li₇Mn₅O₁₂, Li₂MnO₃, Li₄Mn₅O₁₂, Li₂Mn₄O₉, and Li₇Mn₅O₁₂.

In the lithium composite oxide, an amount of lithium ions may be about 1% to about 20%, about 2% to about 20%, about 5% to about 20%, about 5% to about 15%, or about 7% to about 18%, of the total amount of lithium ions in the cathode active material, (e.g., if the battery is fully discharged). For example, the amount of lithium ions in the lithium composite oxide may about 1 mol % to about 20 mol %, about 2 mol % to about 20 mol %, about 5 mol % to about 20 mol %, about 5 mol % to about 15 mol %, or about 7 mol % to about 18 mol %, based on 100 mol % of lithium ions in the cathode active material, (e.g., if the battery is fully discharged).

In one or more embodiments, an amount of the lithium composite oxide may be about 10 parts by weight to about 90 parts by weight, about 20 parts by weight to about 80 parts by weight, about 30 parts by weight to about 70 parts by weight, or about 40 parts by weight to about 90 parts by weight, based on 100 parts by weight of the cathode active material.

A volumetric expansion ratio of the cathode active material according to one or more embodiments may be, at most, about 1% to about 15%. Herein, “volumetric expansion ratio” is a volume of the discharged cathode active material divided by a volume of the charged cathode active material, “discharged” refers to a state of at least 85%, at least 90%, at least 95%, or 100% discharge, and “charged” refers to a state of at least 85%, at least 90%, at least 95%, or 100% charged. For example, the volumetric expansion ratio of the cathode active material may be about 1% to about 15%, about 2% to about 10%, about 3% to about 8%. A volumetric expansion ratio of the exterior coating according to one or more embodiments may be, at most, about 1% to about 15%, (e.g., about 1% to about 15%, about 2% to about 10%, about 3% to about 8%). A volumetric expansion ratio of the shell according to one or more embodiments may be, at most, about 1% to about 15%, (e.g., about 1% to about 15%, about 2% to about 10%, about 3% to about 8%). A volumetric expansion ratio of the lithium composite oxide according to one or more embodiments may be, at most, about 1% to about 15%, (e.g., about 1% to about 15%, about 2% to about 10%, about 3% to about 8%).

### Particles

The cathode active material according to one or more embodiments may include or be in the form of particles each including a core and a shell on the core. For example, the shell may be on a surface of the core of the particles. The core according to one or more embodiments may be or include the layered metal oxide as described herein, (e.g., the core may be the interior of the CAM). The shell according to one or more embodiments be or include the lithium composite oxide as described herein, (e.g., the shell may be the exterior coating interior of the CAM). The shell surrounds the entire surface of the core of each particle, and may be in the form of a film that continuously surrounds the surface of the core. If the shell including the lithium composite oxide is formed on the core, then the capacity, stability and cycle-life characteristics at high voltage may be further improved.

The particles may have an average particle diameter of about 30 micrometer (μm). In one or more embodiments, an average particle diameter (D₅₀) of the particles may be, for example, about 1 μm to about 30 μm. If the average particle diameter (D₅₀) satisfies the described range, high capacity and long cycle-life may be achieved, and formation of the shell according to one or more embodiments may be facilitated. As an example, the cathode active material may be large particles having an average particle diameter (D₅₀) of about 9 μm to about 25 μm, or may be small particles having an average particle diameter (D₅₀) of about 0.5 μm to about 8 μm, and the large particles and small particles may be appropriately or suitably mixed. The average particle diameter (D₅₀) of the large particles may be, for example, about 10 μm to about 20 μm, or about 12 μm to about 18 μm, and the average particle diameter (D₅₀) of the small particles may be, for example, about 1 μm to about 6 μm, or about 2 μm to about 5 μm. If the cathode active material includes a mixture of large and small particles, the large particles may be included in an amount of about 60 wt % to about 95 wt %, or about 70 wt % to about 90 wt %, and the small particles may be included in an amount of about 5 wt % to about 40 wt %, or about 10 wt % to about 30 wt %.

The shape of the particles and/or the core may each independently be selected from among irregular, spherical, semi-spherical, and elliptical.

An average particle diameter of the core according to one or more embodiments may be about 60% to about 90% of the average particle diameter of the particles. For example, an average particle diameter (D₅₀) of the core may be about 18 μm to about 27 μm, or about 20 μm to about 24 μm. In one or more embodiments, an average particle diameter (D₅₀) of a core of the large particles may be, for example, about 8 μm to about 22.5 μm, and an average particle diameter (D₅₀) of a core of the small particles may be, for example, about 0.4 μm to about 8.1 μm.

A thickness of the shell according to one or more embodiments may be about 5% to about 30% of the average particle diameter (D₅₀) of the particles. For example, the thickness of the shell may be about 1.5 μm to about 9 μm, or about 2 μm to about 8 μm. In one or more embodiments, a thickness of the shell of the large particles may be or about 1.3 μm to about 7.5 μm, and a thickness of the shell of the small particles may be about 0.3 μm to about 2.4 μm. The thickness of the shell according to one or more embodiments may be about 30 nanometer (nm) to about 500 nm, for example, about 30 nm to about 450 nm, about 30 nm to about 400 nm, about 30 nm to about 350 nm, about 30 nm to about 300 nm, about 30 nm to about 250 nm, about 30 nm to about 200 nm, about 30 nm to about 150 nm, about 50 nm to about 500 nm, about 80 nm to about 500 nm, or about 100 nm to about 500 nm.

If the thickness of the shell is within the described ranges, the structural stability of the cathode active material may be improved without reducing capacity, and degradation of the cathode active material may be eliminated (e.g., effectively suppressed or reduced). The thickness of the shell may be measured using, (e.g., time-of-flight secondary-ion mass spectrometry (TOF-SIMS), X-ray photoelectron spectroscopy (XPS), or energy-dispersive X-ray spectroscopy (EDS) analysis), and the thickness range of the shell may be measured through transmission electron microscopy-energy dispersive X-ray spectroscopy (TEM-EDS) line profile. In one or more embodiments, the shell has a substantially uniform thickness.

### Gradient Structure of Particles

The particles of the cathode active material according to one or more embodiments may include an external region, a middle region, and an internal region.

The external region has a first inner boundary and a first surface that is coincident (e.g., has substantially the same boundaries) with the surface of the shell. A first thickness of the external region according to one or more embodiments may be about 5% to about 40% of the average particle diameter of the particles. For example, the first thickness may be about 1.5 μm to about 12 μm, or about 2 μm to about 10 μm. In one or more embodiments, a first thickness of a shell of the large particles may be about 1.3 μm to about 10 μm, and a first thickness of a shell of the small particles may be or about 0.3 μm to about 3.2 μm.

The middle region has a second inner boundary and a second surface that is coincident with the first inner boundary. A second thickness of the middle region according to one or more embodiments may be about 5% to about 40% of the average particle diameter of the particles. For example, the second thickness may be about 1.5 μm to about 12 μm, or about 2 μm to about 10 μm. In one or more embodiments, a second first thickness of a shell of the large particles may be about 1.3 μm to about 10 μm, and a second thickness of a shell of the small particles may be or about 0.3 μm to about 3.2 μm.

The internal region has a third surface and a sphere-like shape having a diameter that is about 60% to about 90% of the average particle diameter of the particles. The term “sphere-like,” as used herein, is a shape selected from among spherical, semi-spherical, elliptical, and irregular. The shape of the internal region according to one or more embodiments may be substantially the same as the shape of the core. The diameter of the third region according to one or more embodiments may be about 18 μm to about 27 μm, or about 20 μm to about 24 μm. In one or more embodiments, a diameter of a third region of the large particles may be, for example, about 8 μm to about 22.5 μm, and a diameter of a third region of the small particles may be, for example, about 0.4 μm to about 8.1 μm.

The external region according to one or more embodiments includes about 5% to about 20%, about 7% to about 15%, or about 8% to about 10% of the total amount of lithium ions in the cathode active material, (e.g., if the battery is fully discharged).

The middle region according to one or more embodiments includes about 10% to about 40%, about 13% to about 35%, or about 18% to about 30% of the total amount of lithium ions in the cathode active material, (e.g., if the battery is fully discharged).

The internal region according to one or more embodiments includes about 60% to about 90%, about 65% to about 85%, or about 70% to about 80% of the total amount of lithium ions in the cathode active material, (e.g., if the battery is fully discharged).

The external region according to one or more embodiments includes about 5% to about 20%, about 7% to about 15%, or about 8% to about 10% of the total amount of lithium ions in the cathode active material, (e.g., if the battery is, at least, about 60% to about 98% discharged, (e.g., about 60%, about 70%, about 80%, about 85%, about 90%, about 92%, about 95%, or about 98% discharged)).

The middle region according to one or more embodiments includes about 10% to about 40%, about 13% to about 35%, or about 18% to about 30% of the total amount of lithium ions in the cathode active material, (e.g., if the battery is, at least, about 60% to about 98% discharged, (e.g., about 60%, about 70%, about 80%, about 85%, about 90%, about 92%, about 95%, or about 98% discharged)).

The internal region according to one or more embodiments includes about 60% to about 90%, about 65% to about 85%, or about 70% to about 80% of the total amount of lithium ions in the cathode active material, (e.g., if the battery is, at least, about 60% to about 98% discharged, (e.g., about 60%, about 70%, about 80%, about 85%, about 90%, about 92%, about 95%, or about 98% discharged)).

### Cathode

In one or more embodiments, a cathode includes a cathode current collector and a cathode active material layer on the cathode current collector, wherein the cathode active material layer includes the aforementioned cathode active material. The cathode active material layer may be arranged on at least one surface (e.g., on one or two opposing surfaces) of the cathode current collector. The cathode active material layer may further include other kinds of cathode active materials in addition to the aforementioned cathode active materials. In embodiments, the cathode active material layer may optionally further include a binder, a conductive material (e.g., an electrically conductive material), and/or a (e.g., any suitable) combination thereof.

According to one or more embodiments, a loading level of the cathode active material layer may be about 10 milligram per square centimeter (mg/cm²) to about 40 mg/cm², for example, about 10 mg/cm² to about 30 about mg/cm², or about 10 mg/cm² to about 20 mg/cm². In embodiments, a density of the cathode active material layer in the final compressed cathode may be about 3.3 gram per cubic centimeter (g/cc) to about 3.7 g/cc, for example, about 3.3 g/cc to about 3.6 g/cc or about 3.4 g/cc to about 3.58 g/cc. If applying the cathode active material according to one or more embodiments, a cathode that satisfies the loading level and cathode density in the described range is suitable for implementing a high-capacity, high-energy-density rechargeable lithium battery.

### Cathode Current Collector

The cathode current collector may be formed in the form of a plate, a foil, and/or the like including (e.g., consisting of), for example, indium (In), copper (Cu), magnesium (Mg), stainless steel, titanium (Ti), iron (Fe), cobalt (Co), nickel (Ni), zinc (Zn), aluminum (Al), germanium (Ge), lithium (Li), and/or an alloy thereof. A thickness of the cathode current collector may be in a range of, for example, about 1 micrometer (μm) to about 100 μm, about 1 μm to about 50 μm, about 5 μm to about 25 μm, or about 10 μm to about 20 μm.

### Binder

The binder improves binding properties of cathode active material particles with one another and with a current collector. Examples of binders may include polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, and nylon, but are not limited thereto.

### Conductive Material

The conductive material is included to provide electrical conductivity and any suitable electrically conductive material may be used as a conductive material unless it causes an undesirable chemical change in the rechargeable lithium battery. Examples of the conductive material may include a carbon-based material such as natural graphite, artificial graphite, carbon black, acetylene black, ketjen black, a carbon fiber, a carbon nanofiber, a carbon nanotube, and/or the like; a metal-based material of a metal powder and/or a metal fiber including copper, nickel, aluminum, silver, and/or the like; an electrically conductive polymer such as a polyphenylene derivative; and/or a (e.g., any suitable) mixture thereof.

Each content (e.g., amount) of the binder and the conductive material may be about 0.5 wt % to about 5 wt % based on 100 wt % of the cathode active material layer.

### Rechargeable Lithium Battery

Some embodiments provide a rechargeable lithium battery including the aforementioned cathode, an anode, and an electrolyte between the cathode and the anode. As an example, the rechargeable lithium battery may include a positive electrode (cathode), a negative electrode (anode), a separator between the positive electrode (cathode) and the negative electrode (anode), and an electrolyte solution.

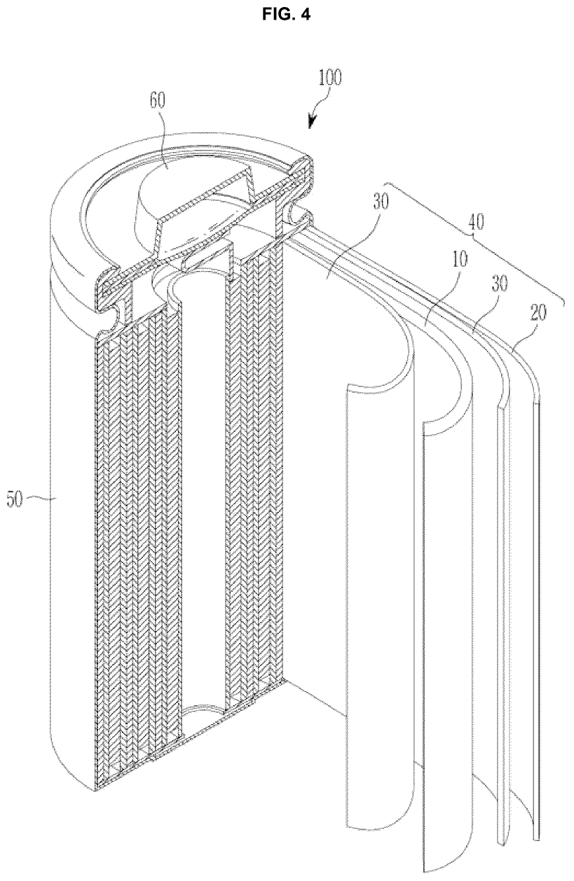

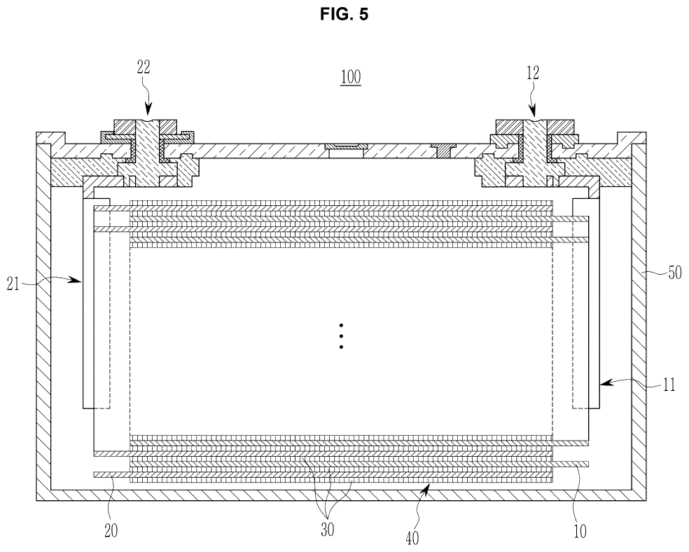

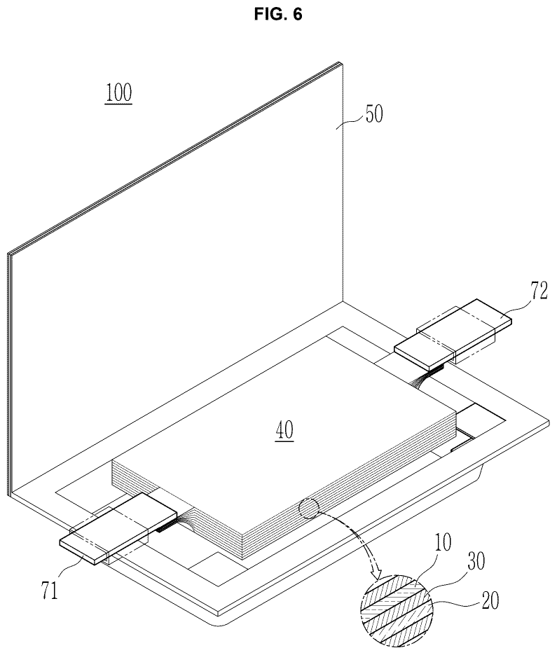

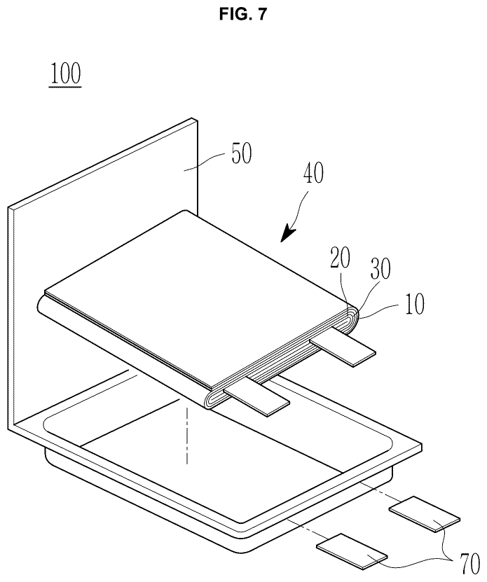

The rechargeable lithium battery may be classified into cylindrical, prismatic, pouch, coin, and/or the like, depending on the shape of the rechargeable lithium battery. FIGS. 4-7 are schematic diagrams showing the rechargeable lithium battery according to one or more embodiments, where FIG. 4 is a cylindrical battery, FIG. 5 is a prismatic battery, and FIGS. 6-7 are each a pouch-shaped battery. Referring to FIGS. 4-7, the rechargeable lithium battery 100 includes an electrode assembly 40 with a separator 30 between the positive electrode (cathode) 10 and the negative electrode (anode) 20, and a case 50 in which the electrode assembly 40 is housed. The positive electrode (cathode) 10, the negative electrode (anode) 20, and the separator 30 may be impregnated with an electrolyte solution. The rechargeable lithium battery 100 may include a sealing member 60 that seals the case 50 as shown in FIG. 4. In FIG. 5, the rechargeable lithium battery 100 may include a positive electrode (cathode) lead tab 11, a positive terminal 12, a negative electrode (anode) lead tab 21, and a negative terminal 22. As shown in FIGS. 6-7, the rechargeable lithium battery 100 includes electrode tabs 70, that may be a positive electrode (cathode) tab 71 and a negative electrode (anode) tab 72, that serves as an electrical path for inducing the current formed in the electrode assembly 40 to the outside.

The rechargeable lithium battery according to one or more embodiments may be rechargeable at a high voltage or may be suitable for being driven at a high voltage. For example, the upper charging limit voltage of a rechargeable lithium battery may be, at least, about 3.5 V, about 3.5 V to about 5 V, about 4 V to about 5 V, about 4.3 V to about 4.9 V, about 4.4 V to about 4.8 V, or about 4.5 V to about 4.7 V, and/or the like. By applying the cathode active material according to one or more embodiments, a rechargeable lithium battery may be charged at high voltage and may achieve high capacity, suitable or excellent stability, and long cycle-life characteristics.

The rechargeable lithium battery according to one or more embodiments of the present disclosure may be applied in vehicles, mobile phones, and/or one or more suitable kinds of electrical devices, but the present disclosure is not limited thereto.

### Method of Operating a Rechargeable Lithium Battery

In one or more embodiments, a method of operating the rechargeable lithium battery includes the act or task of charging the battery to an upper limit voltage of, at least, about 3.5 volt (V). For example, the upper limit voltage may be, at least, about 3.5 V to about 5 V, about 4 V to about 5 V, about 4.3 V to about 4.9 V, about 4.4 V to about 4.8 V, about 4.5 V to about 4.7 V, and/or the like. In one or more embodiments, the method includes the step (e.g., act or task) of operating the battery between a lithiation onset voltage V_{Li} and a dilithiation onset voltage V_{De-Li}, as described herein. In one or more embodiments, the method includes the act or task of operating the battery between about 2.3 V and about 5 V. For example, the battery may be operated between about 3.5 V and about 5 V, about 4 V and about 5 V, about 4.3 V and about 4.9 V, about 4.2 V and about 4.6 V, about 4.2 V and about 4.9 V, 4.3 V and about 4.5 V, about 4.4 V and about 4.8 V, about 4.5 V and about 4.7 V, and/or the like.

A ratio (B/A) according to one or more embodiments of the method may be at least one selected from among an initial charge capacity (B) of the interior to an initial charge capacity (A) of the exterior coating, an initial charge capacity (B) of the layered metal oxide to an initial charge capacity (A) of the lithium composite oxide, and an initial charge capacity (B) of the core to an initial charge capacity (A) of the shell. The ratio (B/A) may be about 5 to about 50, about 8 to about 45, about 10 to about 40, or about 20 to about 30.

The layered metal oxide of the cathode active material according to one or more embodiments of the method may release about 40% to about 100% of an electromotive lithium ion capacity and may retain about 5% to about 60% of the electromotive lithium ion capacity, based on a theoretical electromotive lithium ion capacity of the layered metal oxide. For example, the layered metal oxide may release about 40% to about 99%, about 50% to about 98%, about 30% to about 80%, or about 40% to about 70% of the electromotive lithium ion capacity. While a range of about 40% to about 100% is disclosed, the amount of electromotive lithium ion capacity released by the layered metal oxide is also contemplated to be about 40%, 45%, 50%, 55%, 60%, 65%, 70%, 75%, 80%, 85%, 90%, 95%, 98%, 99%, or 100%, or a value falling in between any two of the preceding single values. In one or more embodiments, the layered metal oxide may retain about 1% to about 30%, about 3% to about 25%, about 5% to about 20%, or about 8% to about 18% of the electromotive lithium ion capacity. While a range of about 1% to about 30% is disclosed, the amount of electromotive lithium ion capacity retained by the layered metal oxide is also contemplated to be about 1%, 3%, 5%, 8%, 10%, 15%, 18%, 20%, 23%, 25%, 28%, 29%, or 30%, or a value falling in between any two of the preceding single values.

The lithium composite oxide of the cathode active material according to one or more embodiments of the method may release about 5% to about 30% of an electromotive lithium ion capacity and may retain about 40% to about 98% of the electromotive lithium ion capacity, based on a theoretical electromotive lithium ion capacity of the lithium composite oxide. For example, the lithium composite oxide may release about 5% to about 30%, about 10% to about 25%, or about 15% to about 20%, the electromotive lithium ion capacity. While a range of about 5% to about 30% is disclosed, the amount of electromotive lithium ion capacity released is also contemplated to be about 5%, 8%, 10%, 15%, 18%, 20%, 23%, 25%, 28%, 29%, or 30%, or a value falling in between any two of the preceding single values. In one or more embodiments, the lithium composite oxide may retain about 40% to about 98%, about 50% to about 90%, about 60% to about 80%, or about 65% to about 75% of the electromotive lithium ion capacity. While a range of about 40% to about 98% is disclosed, the amount of electromotive lithium ion capacity retained is also contemplated to be about 40%, 45%, 50%, 55%, 60%, 65%, 70%, 75%, 80%, 85%, 90%, 95%, or 98%, or a value falling in between any two of the preceding single values.

### Anode

The anode may include a current collector and an anode active material layer on the current collector, and the anode active material layer may include an anode active material, and may further include a binder, an electrically conductive material, and/or a (e.g., any suitable) combination thereof.

### Anode Active Material

The anode active material may include a material that reversibly intercalates/deintercalates lithium ions, a lithium metal, a lithium metal alloy, a material capable of doping/dedoping lithium, and/or transition metal oxide.

The material that reversibly intercalates/deintercalates lithium ions may include, for example, crystalline carbon, amorphous carbon, and/or a (e.g., any suitable) combination thereof as a carbon-based anode active material. The crystalline carbon may be irregular, or sheet, flake, spherical, or fiber shaped (e.g., in a form of fibers) and may be or include natural graphite and/or artificial graphite. The amorphous carbon may be a soft carbon, a hard carbon, a mesophase pitch carbonization product, calcined coke, and/or the like.

The lithium metal alloy includes an alloy of lithium and a metal selected from among Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based anode active material and/or a Sn-based anode active material. The Si-based anode active material may include silicon, a silicon-carbon composite, SiOx (0<x≤2), a Si-Q alloy (wherein Q is an element selected from among an alkali metal, an alkaline-earth metal, a Group 13 element, a Group 14 element (excluding Si), a Group 15 element, a Group 16 element, a transition metal, a rare earth element, and/or a (e.g., any suitable) combination thereof, for example, Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and/or a (e.g., any suitable) combination thereof), and/or a (e.g., any suitable) combination thereof. The Sn-based anode active material may be Sn, SnO₂, SiOx (0<x<2), a Sn alloy, and/or a (e.g., any suitable) combination thereof.

The silicon-carbon composite may be a composite of silicon and amorphous carbon. An average particle diameter (D₅₀) of the silicon-carbon composite particles may be, for example, about 0.5 μm to about 20 μm. According to one or more embodiments, the silicon-carbon composite may be in the form of silicon particles and amorphous carbon coated on the surface of the silicon particles. For example, it may include a secondary particle (core) in which silicon primary particles are assembled and an amorphous carbon coating layer (shell) on the surface of the secondary particle. The amorphous carbon may also be present between the silicon primary particles, for example, the silicon primary particles may be coated with amorphous carbon. The secondary particles may exist dispersed in an amorphous carbon matrix.

The silicon-carbon composite may further include crystalline carbon. For example, the silicon-carbon composite may include a core including crystalline carbon and silicon particles and an amorphous carbon coating layer on the surface of the core. The crystalline carbon may be artificial graphite, natural graphite, and/or a (e.g., any suitable) combination thereof. The amorphous carbon may include soft carbon and/or hard carbon, a mesophase pitch carbonized product, and/or calcined coke.

If the silicon-carbon composite includes silicon and amorphous carbon, a content (e.g., amount) of silicon may be about 10 wt % to about 50 wt % and a content (e.g., amount) of amorphous carbon may be about 50 wt % to about 90 wt % based on 100 wt % of the silicon-carbon composite. In some embodiments, if the composite includes silicon, amorphous carbon, and crystalline carbon, a content (e.g., amount) of silicon may be about 10 wt % to about 50 wt %, a content (e.g., amount) of crystalline carbon may be about 10 wt % to about 70 wt %, and a content (e.g., amount) of amorphous carbon may be about 20 wt % to about 40 wt % based on 100 wt % of the silicon-carbon composite.

In embodiments, a thickness of the amorphous carbon coating layer may be about 5 nanometer (nm) to about 100 nm. An average particle diameter (D₅₀) of the silicon particles (primary particles) may be about 10 nm to about 1 μm, or about 10 nm to about 200 nm. The silicon particles may exist as silicon alone, in the form of a silicon alloy, and/or in an oxidized form. The oxidized form of silicon may be represented by SiOₓ (0<x≤2). At this time, the atomic content (e.g., amount) ratio of Si:O, which indicates a degree of oxidation, may be about 99:1 to about 33:67. As used herein, if (e.g., when) a definition is not otherwise provided, an average particle diameter (D₅₀) indicates a particle where an accumulated volume is about 50 volume % in a particle distribution.

The Si-based anode active material and/or Sn-based anode active material may be mixed with the carbon-based anode active material. If the Si-based anode active material and/or Sn-based anode active material and the carbon-based anode active material are mixed and used, the mixing ratio may be a weight ratio of about 1:99 to about 90:10.

### Binder

The binder serves to well adhere the anode active material particles to each other and also to adhere the anode active material to the current collector. The binder may be a non-aqueous binder, an aqueous binder, a dry binder, and/or a (e.g., any suitable) combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, and/or a (e.g., any suitable) combination thereof.

The aqueous binder may include a styrene-butadiene rubber, a (meth)acrylated styrene-butadiene rubber, a (meth)acrylonitrile-butadiene rubber, a (meth)acrylic rubber, a butyl rubber, a fluorine rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and/or a (e.g., any suitable) combination thereof.

If an aqueous binder is used as the anode binder, a cellulose-based compound capable of imparting or increasing viscosity may be further included. As the cellulose-based compound, one or more of carboxymethyl cellulose, hydroxypropylmethyl cellulose, methyl cellulose, or alkali metal salts thereof may be mixed and used. The alkali metal may be Na, K, or Li.

The dry binder may be a polymer material capable of becoming fiberized, and may be, for example, polytetrafluoroethylene, polyvinylidene fluoride, a polyvinylidene fluoride-hexafluoropropylene copolymer, polyethylene oxide, and/or a (e.g., any suitable) combination thereof.

### Conductive Material

The conductive material is included to provide electrode conductivity (e.g., electrical conductivity) and any suitable electrically conductive material may be used as a conductive material unless it causes an undesirable chemical change in the rechargeable lithium battery. Examples of the conductive material include a carbon-based material such as natural graphite, artificial graphite, carbon black, acetylene black, ketjen black, a carbon fiber, a carbon nanofiber, a carbon nanotube, and/or the like; a metal-based material of a metal powder and/or a metal fiber including copper, nickel, aluminum silver, and/or the like; an electrically conductive polymer such as a polyphenylene derivative; and/or a (e.g., any suitable) mixture thereof.

A content (e.g., amount) of the anode active material may be about 95 wt % to about 99.5 wt % based on 100 wt % of the anode active material layer, and a content (e.g., amount) of the binder may be about 0.5 wt % to about 5 wt % based on 100 wt % of the anode active material layer. For example, the anode active material layer may include about 90 wt % to about 99 wt % of the anode active material, about 0.5 wt % to about 5 wt % of the binder, and about 0.5 wt % to about 5 wt % of the conductive material.

### Current Collector

The anode current collector may include, for example, indium (In), copper (Cu), magnesium (Mg), stainless steel, titanium (Ti), iron (Fe), cobalt (Co), nickel (Ni), zinc (Zn), aluminum (Al), germanium (Ge), lithium (Li), and/or an alloy thereof, and may be in the form of a foil, sheet, and/or foam. A thickness of the anode current collector may be, for example, about 1 μm to about 20 μm, about 5 μm to about 15 μm, or about 7 μm to about 10 μm.

### Electrolyte

For example, the electrolyte for a rechargeable lithium battery may be an electrolyte, which may include a non-aqueous organic solvent and a lithium salt.

The non-aqueous organic solvent serves as a medium that transmits ions taking part in the electrochemical reaction of a battery. The non-aqueous organic solvent may be a carbonate-based, ester-based, ether-based, ketone-based, and/or alcohol-based solvent, an aprotic solvent, and/or a (e.g., any suitable) combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. The ester-based solvent may include methyl acetate, ethyl acetate, n-propyl acetate, dimethyl acetate, methyl propionate, ethyl propionate, decanolide, mevalonolactone, valerolactone, caprolactone, and/or the like. The ether-based solvent may include dibutyl ether, tetraglyme, diglyme, dimethoxyethane, 2-methyltetrahydrofuran, 2,5-dimethyltetrahydrofuran, tetrahydrofuran, and/or the like. In some embodiments, the ketone-based solvent may include cyclohexanone, and/or the like. The alcohol-based solvent may include ethanol, isopropyl alcohol, and/or the like and the aprotic solvent may include nitriles such as R—CN (wherein R is a C2 to C20 linear, branched, or cyclic hydrocarbon group, a double bond, an aromatic ring, or an ether group, and/or the like); amides such as dimethylformamide; dioxolanes such as 1,3-dioxolane, 1,4-dioxolane, and/or the like; sulfolanes, and/or the like.

The non-aqueous organic solvent may be used alone or in a mixture of two or more types (kinds), and if two or more kinds are used in a mixture, a mixing ratio may be appropriately or suitably adjusted according to the desired or suitable battery performance.

If using a carbonate-based solvent, a cyclic carbonate and a chain carbonate may be mixed and used, and the cyclic carbonate and the chain carbonate may be mixed in a volume ratio of about 1:1 to about 1:9.

The non-aqueous organic solvent may further include an aromatic hydrocarbon-based organic solvent. For example, a carbonate-based solvent and an aromatic hydrocarbon-based organic solvent may be mixed and used in a volume ratio of about 1:1 to about 30:1.

The electrolyte may further include vinylethyl carbonate, vinylene carbonate, and/or an ethylene carbonate-based compound to improve battery cycle-life.

Examples of the ethylene carbonate-based compound may include fluoroethylene carbonate, difluoroethylene carbonate, chloroethylene carbonate, dichloroethylene carbonate, bromoethylene carbonate, dibromoethylene carbonate, nitroethylene carbonate, and cyanoethylene carbonate.

The lithium salt dissolved in the organic solvent supplies lithium ions in a battery, enables a basic operation of a rechargeable lithium battery, and improves transportation of the lithium ions between positive and anodes. Examples of the lithium salt may include at least one selected from among LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide; LiFSI), LiC₄F₉SO₃, LiN(CₓF₂ₓ₊₁SO₂)(C_{y}F_{2y+1}SO₂) (wherein x and y are integers of 1 to 20), lithium trifluoromethane sulfonate, lithium tetrafluoroethane sulfonate, lithium difluorobis(oxalato)phosphate (LiDFOB), and lithium bis(oxalato)borate (LiBOB).

A concentration of lithium salt may be within the range of about 0.1 M to about 2.0 M. If the concentration of lithium salt is within the described range, the electrolyte has appropriate or suitable ionic conductivity and viscosity, and thus excellent or suitable performance may be achieved and lithium ions may move effectively.

### Separator

Depending on the kind of the rechargeable lithium battery, a separator may be present between the cathode and the anode. The separator may include polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and/or the like.

The separator may include a porous substrate and a coating layer including an organic material, an inorganic material, and/or a (e.g., any suitable) combination thereof on one or both surfaces (e.g., opposite surfaces) of the porous substrate.

The porous substrate may be a polymer film formed of any one polymer selected from among polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The porous substrate may have a thickness of about 1 μm to about 40 μm, for example, about 1 μm to about 30 μm, about 1 μm to about 20 μm, about 5 μm to about 15 μm, or about 10 μm to about 15 μm.

The organic material may include a (meth)acrylic copolymer including a first structural unit derived from (meth)acrylamide, and a second structural unit including at least one of a structural unit derived from (meth)acrylic acid or (meth)acrylate, and a structural unit derived from (meth)acrylamidosulfonic acid or a salt thereof.

The inorganic material may include inorganic particles selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and/or a (e.g., any suitable) combination thereof, but the present disclosure is not limited thereto. An average particle diameter (D₅₀) of the inorganic particles may be about 1 nm to about 2000 nm, for example, about 100 nm to about 1000 nm, or about 100 nm to about 700 nm.

The organic material and the inorganic material may be mixed in one coating layer, or a coating layer including an organic material and a coating layer including an inorganic material may be stacked.

The thickness of the coating layer may be about 0.5 μm to about 20 μm, for example, about 1 μm to about 10 μm, or about 1 μm to about 5 μm.

Terms such as “substantially,” “about,” and “approximately” are used as relative terms and not as terms of degree, and are intended to account for the inherent deviations in measured or calculated values that would be recognized by those of ordinary skill in the art. They may be inclusive of the stated value and an acceptable range of deviation as determined by one of ordinary skill in the art, considering the limitations and error associated with measurement of that quantity. For example, “about” may refer to one or more standard deviations, or ±30%, 20%, 10%, 5% of the stated value.

Numerical ranges disclosed herein include and are intended to disclose all subsumed sub-ranges of the same numerical precision. For example, a range of “1.0 to 10.0” includes all subranges having a minimum value equal to or greater than 1.0 and a maximum value equal to or less than 10.0, such as, for example, 2.4 to 7.6. Applicant therefore reserves the right to amend this specification, including the claims, to expressly recite any sub-range subsumed within the ranges expressly recited herein.

A battery management system (BMS) device, and/or any other relevant devices or components according to embodiments of the present disclosure described herein may be implemented utilizing any suitable hardware, firmware (e.g., an application-specific integrated circuit), software, or a combination of software, firmware, and hardware. For example, the components of the device may be formed on one integrated circuit (IC) chip or on separate IC chips. Further, the components of the device may be implemented on a flexible printed circuit film, a tape carrier package (TCP), a printed circuit board (PCB), or formed on one substrate. Further, the components of the device may be a process or thread, running on one or more processors, in one or more computing devices, executing computer program instructions and interacting with other system components for performing the functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, and/or the like. Also, a person of skill in the art should recognize that the functionality of computing devices may be combined or integrated into a single computing device, or the functionality of a particular computing device may be distributed across one or more other computing devices without departing from the scope of the present disclosure.

Example embodiments of the present disclosure have been described, but the present disclosure is not limited thereto. One or more suitable other modifications may be implemented within the scope of the claims, the detailed description of the present disclosure, and the appended drawings, and are also included in the scope of the present disclosure. Accordingly, any modified embodiments may not be understood separately from the technical ideas and aspects of the present disclosure, and the modified embodiments are within the scope of the appended claims and equivalents thereof.

Reference Numerals

| | |
|---|---|
| 110: high cutoff voltage | 120: low cutoff voltage |
| 210: delithiation onset voltage | 220: lithiation onset voltage |
| 100: rechargeable lithium battery | 10: positive electrode |
| 11: positive electrode lead tab | 12: positive terminal |
| 20: negative electrode | 21: negative electrode lead tab |
| 22: negative terminal | 30: separator |
| 40: electrode assembly | 50: case |
| 60: sealing member | 70: electrode tab |
| 71: positive electrode tab | 72: negative electrode tab |

What is claimed is:

1. A cathode active material comprising:
an interior and an exterior coating on the interior, and a total amount of lithium ions,
the interior comprising a layered metal oxide, the exterior coating comprising a lithium composite oxide having a spinel structure,
the cathode active material being for a rechargeable lithium battery having an upper charging limit voltage of, at least, about 3.5 volt (V),
the layered metal oxide comprising about 70% to about 90% of the total amount of lithium ions, and the lithium composite oxide comprising about 5% to about 20% of the total amount of lithium ions.

2. The cathode active material of claim 1, wherein:
the layered metal oxide has a high cutoff voltage V_{HI} and a low cutoff voltage V_{LO}, the low cutoff voltage V_{LO} being, at most, about 2.5 V,
the lithium composite oxide has a lithiation onset voltage V_{Li} and a dilithiation onset voltage V_{De-Li},
the dilithiation onset voltage V_{De-Li} being greater than the high cutoff voltage V_{HI} and, at least, about 4.6 V, and
the lithiation onset voltage V_{Li} being less than the low cutoff voltage V_{LO}.

3. The cathode active material of claim 1, wherein the layered metal oxide is represented by Chemical Formula 1 and the lithium composite oxide is represented by Chemical Formula 2: 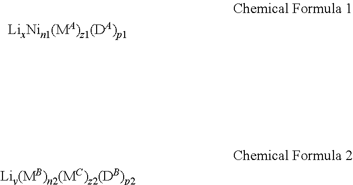
in Chemical Formula 1 and Chemical Formula 2,
M^{A} is aluminum (Al), cobalt (Co), manganese (Mn), chromium (Cr), iron (Fe), magnesium (Mg), strontium (Sr), vanadium (V), a rare earth element, or a combination thereof,
M^{B} and M^{C} are each independently aluminum (Al), nickel (Ni), cobalt (Co), manganese (Mn), chromium (Cr), iron (Fe), magnesium (Mg), strontium (Sr), vanadium (V), a rare earth element, or a combination thereof,
D^{A} and D^{B} are each independently oxygen (O), fluorine (F), sulfur(S), phosphorous (P), or a combination thereof,
x is a real number from 0 to 1.5,
y is a real number from 0 to 2,
n1 is a real number from 0.8 to 1,
n2 is a real number from 0 to 1,
z1 is a real number from 0 to 0.3,
z2 is a real number from 0 to 2,
p1 is a real number from 1.8 to 4,
p2 is a real number from 1.8 to 2, and
n1+z1 and n2+z2 each independently equal 1.

4. The cathode active material of claim 3, wherein the layered metal oxide is represented by Chemical Formula 1A: 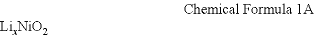
and x is a real number from 0 to 1.

5. The cathode active material of claim 3, wherein the lithium composite oxide is represented by Chemical Formula 2A: 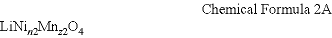
n2 is a real number from 0 to 0.6,
z2 is a real number from 1.4 to 2.

6. The cathode active material of claim 1, wherein an amount of the layered metal oxide is about 10 parts by weight to about 90 parts by weight, based on 100 parts by weight of the cathode active material.

7. The cathode active material of claim 1, wherein an amount of the lithium composite oxide is about 10 parts by weight to about 60 parts by weight, based on 100 parts by weight of the cathode active material.

8. The cathode active material of claim 1, wherein a volumetric expansion ratio of the cathode active material is, at most, about 1% to about 15%.

9. The cathode active material of claim 1, wherein the cathode active material comprises particles comprising a core and shell on the core, the core comprising the layered metal oxide and the shell comprising the lithium composite oxide,
wherein an average particle diameter of the particles is about 30 micrometer (μm), and an average particle diameter of the core is about 60% to about 90% of the average particle diameter of the particles.

10. The cathode active material of claim 9, wherein a thickness of the shell is about 5% to about 30% of the average particle diameter.

11. The cathode active material of claim 9, wherein the particles further comprise:
an external region comprising a first inner boundary and a first surface coincident with a surface of the shell, and having a first thickness of about 5% to about 40% of the average particle diameter;
a middle region having a second inner boundary and a second surface coincident with the first inner boundary and having a second thickness of about 5% to about 40% of the average particle diameter; and
an internal region having a third surface and a sphere-like shape having a diameter of about 60% to about 90% of the average particle diameter.

12. The cathode active material of claim 11, wherein:
the external region comprises about 5% to about 20% of the total amount of lithium ions when the battery is fully discharged,
the middle region comprises about 10% to about 40% of the total amount of lithium ions when the battery is fully discharged, and
the internal region comprises about 60% to about 90% of the total amount of lithium ions when the battery is fully discharged.

13. A rechargeable lithium battery comprising:
a cathode comprising the cathode active material of claim 1;
an anode; and
an electrolyte between the cathode and the anode.

14. The rechargeable lithium battery of claim 13, wherein the cathode further comprises a cathode current collector and a cathode active material layer on at least one surface of the cathode current collector, the cathode active material layer comprising the cathode active material.

15. A method of operating a rechargeable lithium battery, the battery comprising the rechargeable lithium battery of claim 13,
wherein the layered metal oxide has a high cutoff voltage V_{HI} and a low cutoff voltage V_{LO}, the low cutoff voltage V_{LO} is, at most, about 2.5 V,
the lithium composite oxide has a lithiation onset voltage V_{Li} and a dilithiation onset voltage V_{De-Li},
the dilithiation onset voltage V_{De-Li} is greater than the high cutoff voltage V_{HI}) and is, at least, about 4.6 V,
the lithiation onset voltage V_{Li} is less than the low cutoff voltage V_{LO},
the method comprising operating the battery from about 2.3 V to about 5 V.

16. The method of claim 15, wherein a ratio (B/A) of an initial charge capacity of the interior (B) to an initial charge capacity of the exterior coating (A) is about 5 to about 50.

17. The method of claim 15, wherein the layered metal oxide releases about 40% to about 100% of an electromotive lithium ion capacity and retains about 1% to about 30% of the electromotive lithium ion capacity, based on a theoretical electromotive lithium ion capacity of the layered metal oxide.

18. The method of claim 15, wherein the lithium composite oxide releases about 5% to about 30% of an electromotive lithium ion capacity and retains about 40% to about 98% of the electromotive lithium ion capacity, based on a theoretical electromotive lithium ion capacity of the lithium composite oxide.

19. The method of claim 15, wherein a volumetric expansion ratio of the cathode active material is, at most, about 5% to about 15%.

20. The method of claim 15, wherein the layered metal oxide is represented by Chemical Formula 1A and the lithium composite oxide is represented by Chemical Formula 2B: 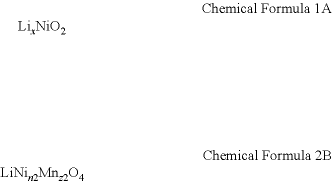
in Chemical Formula 1A, x is a real number from 0 to 1,
in Chemical Formula 2B, n2 is a real number from 0.1 to 0.8, and z2 is a real number from 1.2 to 2, and
wherein the method comprises operating the battery between about 4 V and about 4.8 V.
